(19) United States
(12) Patent Application Publication
(10) Pub. No.: US 2023/0195848 A1
(43) Pub. Date: Jun. 22, 2023

(54) PATTERN EXTRACTION APPARATUS, PATTERN EXTRACTION METHOD AND PROGRAM

(71) Applicant: NIPPON TELEGRAPH AND TELEPHONE CORPORATION, Tokyo (JP)

(72) Inventor: Shinobu SAITO, Tokyo (JP)

(73) Assignee: NIPPON TELEGRAPH AND TELEPHONE CORPORATION, Tokyo (JP)

(21) Appl. No.: 17/918,302

(22) PCT Filed: Apr. 15, 2020
(86) PCT No.: PCT/JP2020/016581

§ 371 Date: Oct. 11, 2022

(51) Int. Cl. G06F 18/22

(52) U.S. Cl. CPC G06F 18/22

(57) ABSTRACT

A pattern extraction apparatus includes a memory and a processor configured to execute calculating, on a basis of a history of an execution process of functions of a system, for each of the functions, a total execution count of the function; identifying the function of which a percentage of the total execution count as to the total execution count of all of the functions or as to a sum of the total execution count is less than a threshold value; and extracting, from patterns of the execution process, a pattern including the function identified by the identifying unit, on the basis of the history.

### TECHNICAL FIELD

The present invention relates to a pattern extraction apparatus, a pattern extraction method and a program.

### BACKGROUND ART

A variety of functions for providing various types of services are sequentially executed within an information system (hereinafter referred to simply as “system”). As the magnitude and complexity of services required for systems increase, the number of patterns of system behavior (execution processes of functions) is reaching an enormous number.

Conventionally, techniques have been disclosed for improving systems, in which patterns of execution processes of functions are visualized from execution data of a system (system log), patterns that occur at a high frequency (high-frequency patterns) are identified from an enormous number of patterns, and functions included in the high-frequency patterns (= frequently used) are extracted as candidates for improvement (e.g., PTL 1).

### CITATION LIST

### Patent Literature

[PTL 1] Japanese Patent Application Publication No. 2017-228257

### SUMMARY OF THE INVENTION

### Technical Problem

Meanwhile, analysis of patterns that rarely occur (rare patterns) is also important for system improvement. Examples of improvement include discarding unused functions (screening functions to be deleted) and integration with other functions.

However, the execution count of patterns have a tendency as shown in FIG. 1. FIG. 1 is a diagram showing a distribution example of the execution count of patterns of execution processes in a system.

In FIG. 1, the horizontal axis corresponds to the number of patterns, and the vertical axis corresponds to the execution count. The number (types) of rare patterns of which the execution count is small tends to be extremely great as compared to the number of high-frequency patterns, as illustrated in FIG. 1.

Accordingly, there is need for technology to efficiently extract patterns including functions that need to be improved (improvement-needed patterns) from an enormous number of rare patterns.

The present invention has been made in view of the above point, and it is an object thereof to efficiently extract patterns including functions that need to be improved out of patterns of execution processes of functions of a system.

### Means for Solving the Problem

In order to solve the above problem, a pattern extraction apparatus includes a calculating unit configured to, on a basis of a history of an execution process of functions of a system, calculate for each of the functions a total execution count of the function; an identifying unit configured to identify the function of which a percentage of the total execution count as to the total execution count of all of the functions or as to a sum of the total execution count is less than a threshold value; and an extracting unit configured to extract, from patterns of the execution process, a pattern including the function identified by the identifying unit, on the basis of the history.

### Effects of the Invention

Patterns including functions that need to be improved can be efficiently extracted out of patterns of execution processes of functions of a system.

### BRIEF DESCRIPTION OF DRAWINGS

FIG. 1 is a diagram showing a conceptual example of patterns of execution processes of a system.

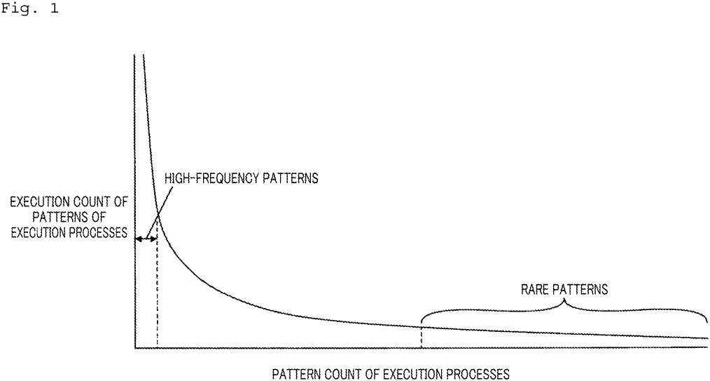

FIG. 2 is a diagram illustrating a hardware configuration example of a pattern extraction apparatus 10 according to a first embodiment.

FIG. 3 is a diagram illustrating a functional configuration example of the pattern extraction apparatus 10 according to the first embodiment.

FIG. 4 is a diagram for describing an overview of extracting improvement-needed patterns according to the first embodiment.

FIG. 5 is a flowchart for describing an example of processing procedures that the pattern extraction apparatus 10 according to the first embodiment executes.

FIG. 6 is a diagram showing a configuration example of a system log.

FIG. 7 is a diagram showing a configuration example of an execution count storage unit 122.

FIG. 8 is a diagram showing an example of calculation results of total execution counts and count percentages of each of functions.

FIG. 9 is a diagram showing an example of determination results of whether the total execution count is minute or not.

FIG. 10 is a diagram showing an example of counting results of the number of object functions included, according to the first embodiment.

FIG. 11 is a diagram for describing an overview of extraction of improvement-needed patterns according to a second embodiment.

FIG. 12 is a flowchart for describing an example of processing procedures that the pattern extraction apparatus 10 according to the second embodiment executes.

FIG. 13 is a diagram showing an example of calculation results of an appearance pattern count for each of functions.

FIG. 14 is a diagram showing an example of determination results of whether the appearance pattern count is minute or not.

FIG. 15 is a diagram showing an example of counting results of the number of object functions included in the second embodiment.

### DESCRIPTION OF EMBODIMENTS

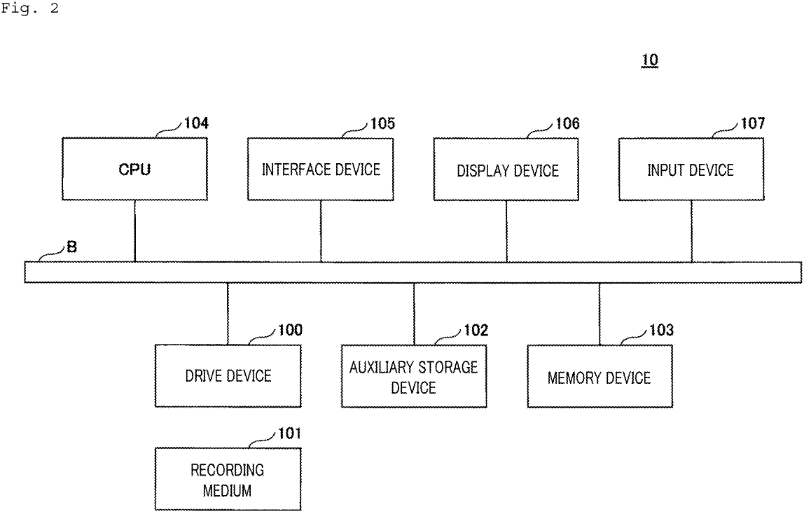

Embodiments of the present invention will be described below with reference to the drawings. FIG. 2 is a diagram illustrating a hardware configuration example of a pattern extraction apparatus 10 according to a first embodiment. The pattern extraction apparatus 10 in FIG. 2 includes a drive device 100, an auxiliary storage device 102, a memory device 103, a CPU 104, an interface device 105, a display device 106, and an input device 107 and so forth, each of which is mutually connected by a bus B.

A program that implements the processing of the pattern extraction apparatus 10 is provided by a recording medium 101 such as a CD-ROM or the like. When the recording medium 101 in which the program is stored is set in the drive device 100, the program is installed from the recording medium 101 to the auxiliary storage device 102 via the drive device 100. Note that the program does not necessarily have to be installed by the recording medium 101, and may be downloaded from another computer over a network. The auxiliary storage device 102 stores necessary files, data, and so forth, and stores the installed program.

In a case in which an activation instruction for the program is given, the memory device 103 reads the program from the auxiliary storage device 102 and stores the program. The CPU 104 implements the functions relating to the pattern extraction apparatus 10, according to the program stored in the memory device 103. The interface device 105 is used as an interface to connect to a network. The display device 106 displays a GUI (Graphical User Interface) or the like according to the program. The input device 107 is constituted with a keyboard, a mouse, and the like, and is used for inputting various types of operation instructions.

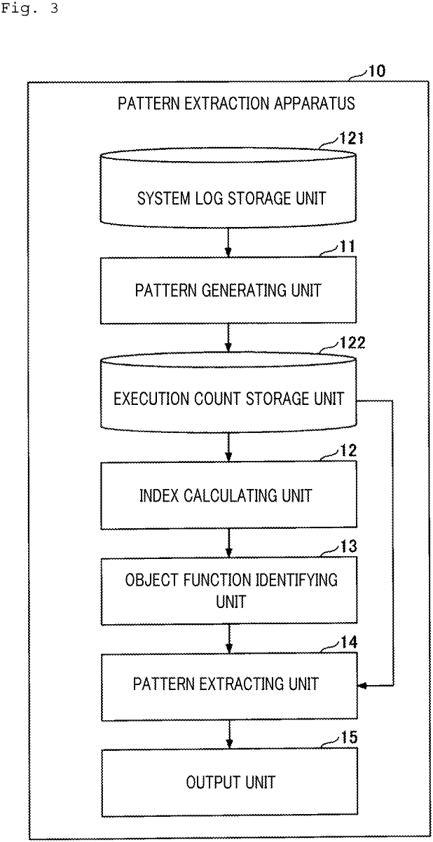

FIG. 3 is a diagram illustrating a functional configuration example of the pattern extraction apparatus 10 according to the first embodiment. In FIG. 3, the pattern extraction apparatus 10 has a pattern generating unit 11, an index calculating unit 12, an object function identifying unit 13, a pattern extracting unit 14, an output unit 15, and so forth.

These parts are implemented by one or more programs installed in the pattern extraction apparatus 10 causing the CPU 104 to execute processing. The pattern extraction apparatus 10 also uses a system log storage unit 121, an execution count storage unit 122, and so forth. These storage units can be implemented by using, for example, the auxiliary storage device 102, a storage device that is connectable to the pattern extraction apparatus 10 over a network, or the like.

In the first embodiment, extraction (searching) of improvement-needed patterns is performed regarding patterns of execution processes of functions (hereinafter referred to simply as “pattern”) of a computer system such as an information system or the like (hereinafter referred to simply as “system”), focusing on total execution counts. An execution process of functions is, for example, information indicating the order in which functions used in a certain task for business (hereinafter referred to as “case”) are executed. The functions to be used, and the order in which the functions are executed, differ from one case to another. For example, in a system including functions A, B, C, D, and so forth, A → B → D is executed in a certain task (Case 1), while A → C → D is executed in a different task (Case 2). In this case, each of “A → B → D” and “A → C → D” is equivalent to a pattern or type of an execution process of functions (hereinafter referred to simply as “pattern”). Note that cases (execution processes) and patterns do not correspond one to one. For example, in a case in which the same execution process appears in a plurality of cases that are different from each other, these execution processes are extracted as one pattern.

Also, an improvement-needed pattern is a pattern regarding which the probability of needing improvement is relatively high, out of a plurality of patterns.

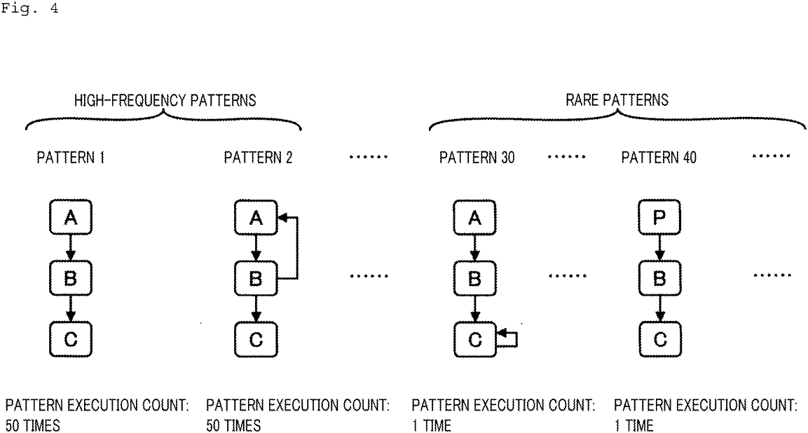

FIG. 4 is a diagram for describing an overview of extracting improvement-needed patterns according to the first embodiment. FIG. 4 shows Pattern 1, Pattern 2, ..., Pattern 30, ..., Pattern 40, and so forth. In each pattern, the rounded squares containing the letters A, B, C, or P represent functions.

In a case in which the execution count of these patterns within a certain period are as listed in the Figure, the execution counts of Pattern 30 and Pattern 40 are extremely small, relatively. That is to say, Pattern 30 and Pattern 40 correspond to rare patterns. Note that the execution counts of patterns are the execution counts based on execution records of each pattern used in the system in the past.

Note that in the first embodiment, patterns including functions of which the total execution count is minute (hereinafter referred to as “object function”) are extracted (searched) as improvement-needed patterns, rather than simply rare patterns. Assume that the total execution count (execution count of each of the functions without distinction among the patterns in past usage of the system) for each of the functions (A, B, C, P) is as follows:
A: 200 times
B: 200 times
C: 300 times
P: two times

In this case, Pattern 30 is constituted with primary functions of which the total execution counts are great (= A, B, C), and only the execution order (flow) of functions is rare in this pattern. In other words, Pattern 30 does not contain any object functions. Accordingly, Pattern 30 does not correspond to an improvement-needed pattern.

Meanwhile, Pattern 40 contains the function P, of which the total execution count is minute. Accordingly, Pattern 40 contains an object function, and is extracted as an improvement-needed pattern. A function P is set as a candidate for deletion, or a candidate for integration with another function or the like, for example.

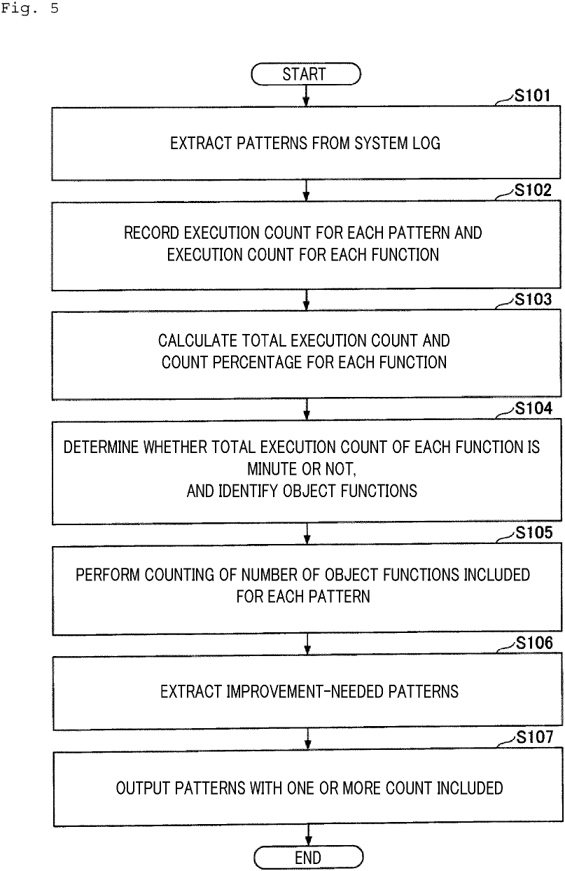

Processing procedures that the pattern extraction apparatus 10 executes in the first embodiment will be described below. FIG. 5 is a flowchart for describing an example of processing procedures that the pattern extraction apparatus 10 according to the first embodiment executes.

In step S101, the pattern generating unit 11 extracts patterns on the basis of the system log stored in the system log storage unit 121.

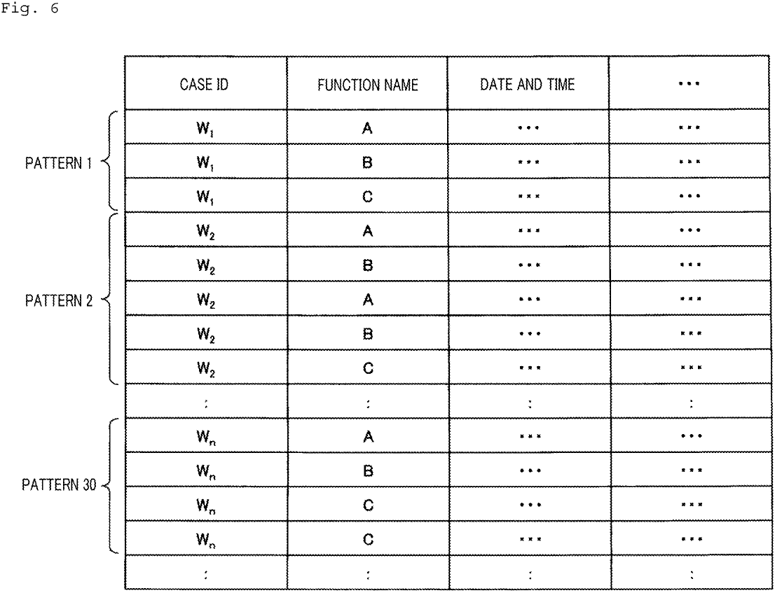

FIG. 6 is a diagram showing a configuration example of a system log. In the present embodiment, each row making up the system log is referred to as “log data”. Log data is recorded in the system log storage unit 121 (added to the system log) each time one function of the system is executed.

In FIG. 6, each record of log data includes case ID, function name, date and time, and so forth. The case ID is unique identification information for each task using the system. The function name is identification information of the function executed in a case related to the case ID. The date and time is date and time when this function was executed.

The order of function names of a log data group with common case IDs is equivalent to the execution process of functions. Accordingly, the system log can be regarded as a history of execution processes of functions.

In step S101, types of execution processes of functions are extracted as patterns. For example, in FIG. 6, an example is illustrated in which an execution process of functions indicated by a log data group of which the case ID is “W₁” (A → B → C) is extracted as Pattern 1, an execution process of functions indicated by a log data group of which the case ID is “W₂” (A → B → A → B → C) is extracted as Pattern 2, and an execution process of functions indicated by a log data group of which the case ID is “Wₙ” (A → B → C → C) is extracted as Pattern 30. These Patterns 1, 2, and 30 correspond to the Patterns 1, 2, and 30 shown in FIG. 4.

Note that extraction of patterns from the system log can be performed using a known technique (e.g., techniques disclosed in PTL 1, Japanese Patent Application Publication 2017-187953, and so forth).

Subsequently, the pattern generating unit 11 records, for each pattern that is extracted, the execution count of the pattern and the execution count of each function in the pattern, in the execution count storage unit 122 (S102).

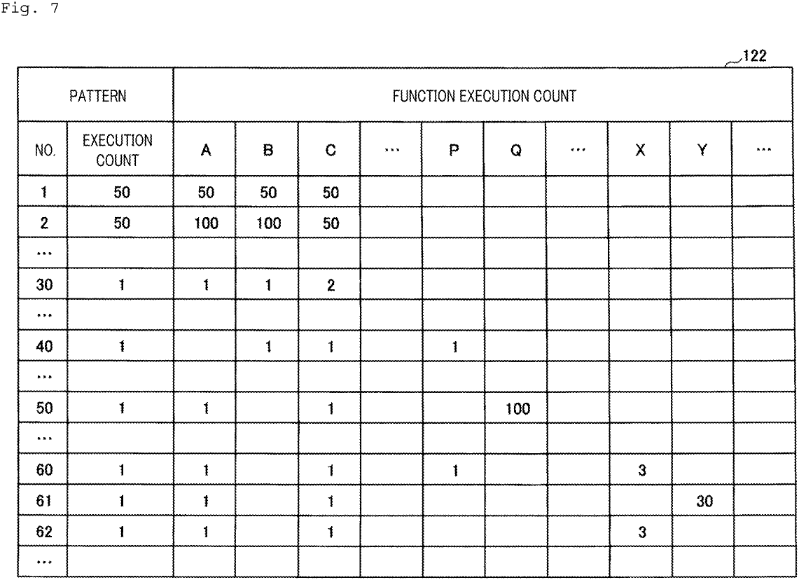

FIG. 7 is a diagram showing a configuration example of the execution count storage unit 122. FIG. 7 shows a table in which patterns are assigned in the row direction and the execution count of the patterns and the execution count of each function (function execution count) are assigned in the column direction, as an example of the configuration of the execution count storage unit 122. The function execution count in each row is the number of times that each function was executed in the pattern corresponding to the row.

For example, at the time of extracting the patterns from the system log, the pattern generating unit 11 can obtain the execution count of each pattern by counting (counting) execution processes of functions matching each pattern in the system log.

Also, by tallying, for each pattern, the execution count for each function in the execution sequence classified to the pattern, the pattern generating unit 11 can obtain the function execution count in the pattern.

Subsequently, the index calculating unit 12 references the execution count storage unit 122 (FIG. 7) to calculate the total execution count and count percentage for each function (S103).

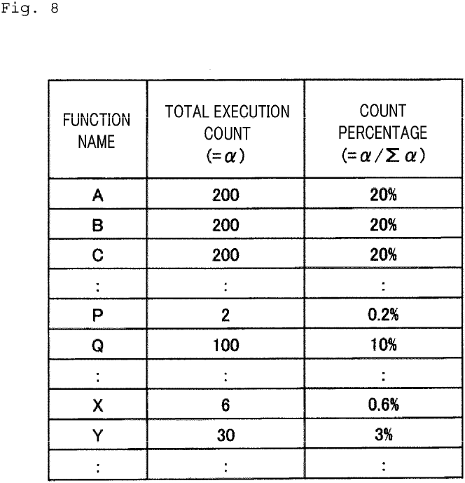

FIG. 8 is a diagram showing an example of calculation results of total execution counts and count percentages of each function. FIG. 8 shows the total execution count and the count percentage for each function. The total execution count of a given function is the number of times that the function name of this function appears in the system log. That is to say, the summation of each column of function execution counts in FIG. 6 is equivalent to the total execution count of the function regarding each column.

In contrast, the count percentage is the percentage of the total execution count of each function as to the sum of the total execution counts of all functions. For example, in a case in which the total execution count of a function is α, the count percentage of the function can be obtained by calculating α/∑α.

Next, the object function identifying unit 13 determines whether or not the total execution count is minute for each function on the basis of the calculation results (FIG. 8) from the index calculating unit 12, and identifies functions of which the respective total execution counts are minute (object functions) (S104). For example, with a threshold value of 1% for the count percentage, a count percentage being less than the threshold value may be set as a condition for the total execution count being minute.

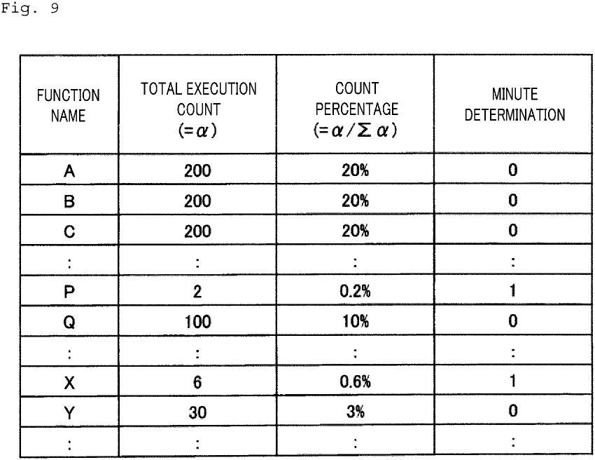

FIG. 9 is a diagram showing an example of determination results of whether the total execution count is minute or not. In FIG. 9, a column of “minute determination” is added to the table shown in FIG. 8. The “minute determination” is an item indicating a determination result of whether the total execution count is minute or not. The value of this item is 1 or 0. 1 indicates a determination result that the total execution count is minute. 0 indicates a determination result that the total execution count is not minute.

FIG. 9 shows determination results in a case in which the count percentage being less than 1% is the condition for the total execution count being minute. Accordingly, the function P of which the count percentage is 0.2%, and a function X of which the count percentage is 0.6%, are determined to be minute with regard to the total execution count. That is to say, in this case, the function P and the function X are identified as object functions.

Note that determination of whether the total execution count is minute or not may be performed on the basis of a threshold value as to the total execution count, instead of the count percentage. For example, the total execution count being less than a threshold value may be the condition for the total execution count being minute.

Subsequently, the pattern extracting unit 14 performs counting (counting) of the number of object functions included in each pattern (S105). The number of object functions included in each pattern can be identified by referencing the execution count storage unit 122 (FIG. 7). Note that the number of object functions included in a pattern means the number of types of object functions included in the pattern. Accordingly, in a case in which the object functions are two types of the function P and the function X, for example, the greatest value of the inclusion number is two.

Specifically, in a case in which the object functions are the function P and the function X, the pattern extracting unit 14 identifies patterns in which the function execution count of the function P or the function X in FIG. 7 is one or more. If the function execution count for only one of the function P and the function X is one or more in this pattern, the pattern extracting unit 14 sets the number of object functions included in this pattern to one. On the other hand, if the function execution counts for both of the function P and the function X are one or more in this pattern, the pattern extracting unit 14 sets the number of object functions included in this pattern to two. Note that the number of object functions included in a pattern whose function execution count is blank for both the function P and the function X is set to zero.

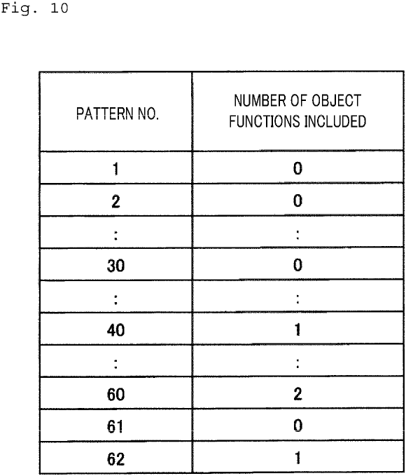

FIG. 10 is a diagram showing an example of counting results of the number of object functions included, according to the first embodiment. FIG. 10 shows counting results of the number of object functions included in a case in which the stored contents of the execution count storage unit 122 are as shown in FIG. 7, and the function P and the function X are object functions.

That is to say, in FIG. 7, with regard to Pattern 40, the function execution count of the function P is one or more, and the function execution count of the function X is blank. With regard to Pattern 60, the function execution counts are one or more for both the functions P and the function X. With regard to Pattern 62, the function execution count of the function P is blank, and the function execution count of the function X is one or more.

From the above, in FIG. 10, the values of the “number of object functions included” for each of Pattern 40, Pattern 60, and Pattern 62 are 1, 2, and 1, respectively, in this order, and the value of the “number of object functions included” for all other patterns is zero.

Subsequently, the pattern extracting unit 14 extracts patterns relating to pattern numbers of which the “number of object functions included” is one or more, as improvement-needed patterns (S106).

Subsequently, the output unit 15 outputs improvement-needed patterns (S107). For example, the pattern numbers of the improvement-needed patterns may be output. At this time, the value of the “number of object functions included” may be used for prioritization. For example, the pattern numbers may be output in descending order of the value of “number of object functions included”. The output unit 15 may also output the function names of object functions included in the patterns related to the pattern numbers, in association with the pattern numbers to be output. Note that the output form is not limited to a specific form. For example, the output form may be a display on the display device 106, or may be preservation in the auxiliary storage device 102, or may be transmission to another device.

The user can reference the output information and identify improvement-needed patterns and improvement-needed functions.

As described above, according to the first embodiment, improvement-needed pattern can be automatically extracted from rare patterns. That is to say, patterns including functions that need improvement can be efficiently extracted out from patterns of execution processes of functions of the system.

Next, a second embodiment will be described. Points that are different from those in the first embodiment will be described in the second embodiment. Points that are not mentioned in particular in the second embodiment may be substantially the same as in the first embodiment.

In the second embodiment, extraction (searching) of improvement-needed pattern is performed focusing on appearance pattern counts of functions.

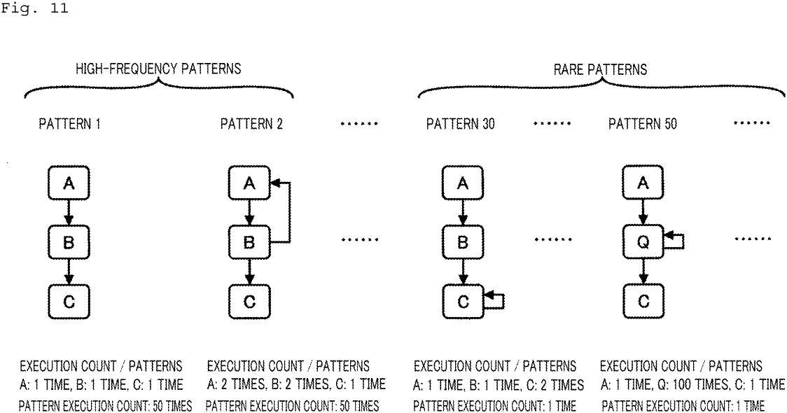

FIG. 11 is a diagram for describing an overview of extraction of improvement-needed patterns according to the second embodiment. Pattern 50 is shown in FIG. 11 instead of Pattern 40.

Also, the execution count of each function per pattern in a certain period (execution count/pattern), and the execution count of each pattern, are shown below the shapes representing the patterns. These execution counts can be derived from the system log. Specifically, in Pattern 1, the “execution count/patterns” for the respective functions A, B, and C are 1, 1, and 1. In Pattern 2, the “execution count/patterns” for the respective functions A, B, and C are 2, 2, and 1. In Pattern 30, the “execution count/patterns” for the respective functions A, B, and C are 1, 1, and 2. In Pattern 50, the “execution count/patterns” for the respective functions A, Q, and C are 1, 100, and 1. That is to say, Q is repeated 100 times each time Pattern 50 is executed.

Here, assuming that the execution counts of the respective Patterns 1, 2, 30, and 50 are as shown in FIG. 7, the total execution counts of the functions A, B, C, and Q are as follows.
A: 200 times
B: 200 times
C: 200 times
Q: 100 times

In this case, the function Q only appears in Pattern 50 which is a rare pattern, and accordingly, conceivably is a function that is not used often in practice. However, the total execution count of the function Q is not minute, and thus the pattern 50 cannot be extracted as an improvement-needed pattern in the first embodiment.

Accordingly, in the second embodiment, patterns including functions whose appearance pattern counts are minute (hereinafter referred to as “object function”) are extracted as improvement-needed patterns. The appearance pattern count of a given function is the number of patterns that include this function (in which this function appears). For example, the appearance pattern count of the function Q is one.

In the example in FIG. 11, Pattern 30 is a rare pattern, but the functions A, B, and C making up Pattern 30 appear in a great number of patterns (e.g., the appearance pattern count is great). In other words, Pattern 30 does not contain functions that correspond to object functions. Accordingly, Pattern 30 does not correspond to an improvement-needed pattern in the second embodiment.

Meanwhile, Pattern 50 contains the function Q that falls under being an object pattern. Accordingly, Pattern 50 is extracted as an improvement-needed pattern in the second embodiment. The function Q is set as a candidate for deletion, or a candidate for integration with another function or the like, for example.

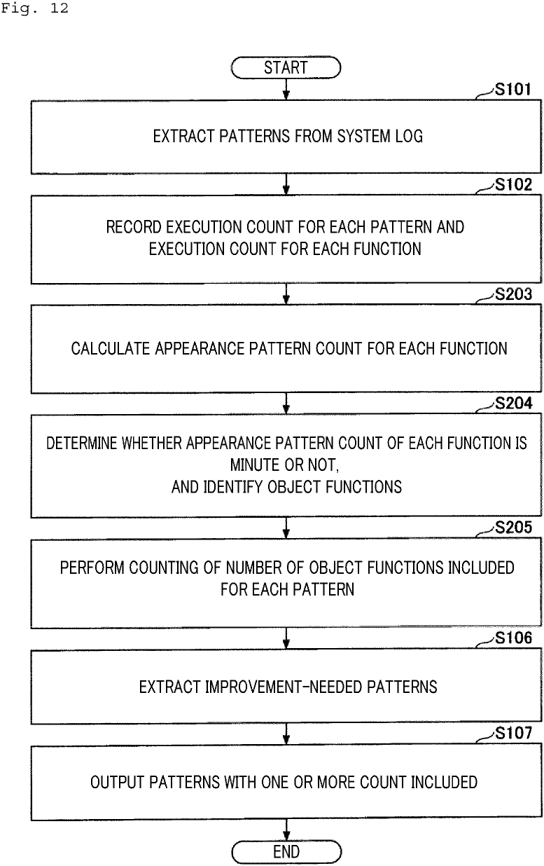

FIG. 12 is a flowchart for describing an example of processing procedures that the pattern extraction apparatus 10 according to the second embodiment executes. In FIG. 12, steps that are the same as in FIG. 5 are denoted by the same step numbers, and description thereof will be omitted.

In step S203, the index calculating unit 12 references the execution count storage unit 122 (FIG. 7) to calculate the appearance pattern count for each function.

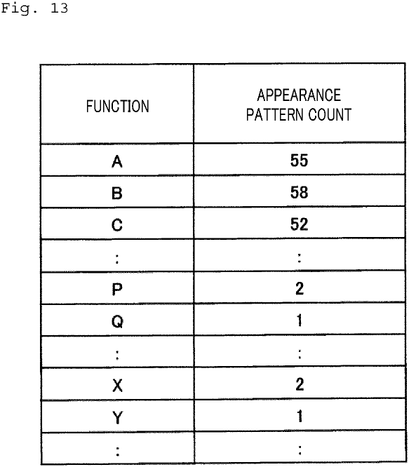

FIG. 13 is a diagram showing an example of calculation results of the appearance pattern count for each function. The appearance pattern count is shown for each function in FIG. 13. The appearance pattern count of a given function is the number of patterns whose function execution count of this function is one or more in FIG. 7. For example, the function execution count of the function Q is one or more only in Pattern 50, and accordingly, the appearance pattern count of the function Q is one. In the same way, the function execution count of the function Y is one or more only in Pattern 61, and accordingly, the appearance pattern count of the function Y is one.

Subsequently, the object function identifying unit 13 determines whether the appearance pattern count is minute or not for each function, on the basis of the calculation results from the index calculating unit 12 (FIG. 13), and identifies functions whose appearance pattern counts are minute (object functions) (S204). For example, with a threshold value of 2 for the appearance pattern count, an appearance pattern count being less than the threshold value may be set as a condition for the appearance pattern count being minute.

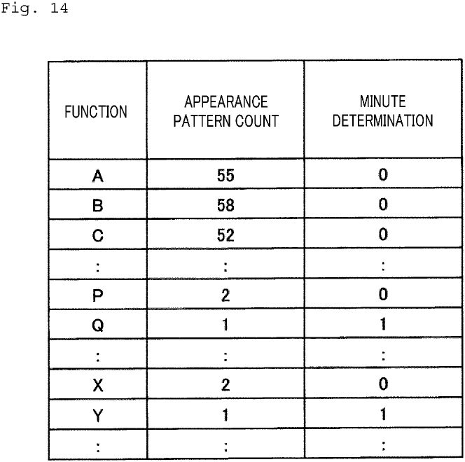

FIG. 14 is a diagram showing an example of determination results of whether appearance pattern counts are minute or not. In FIG. 14, a column of “minute determination” is added to the table shown in FIG. 13. The “minute determination” is an item indicating a determination result of whether the appearance pattern count is minute or not. The value of this item is 1 or 0. 1 indicates a determination result that the appearance pattern count is minute. 0 indicates a determination result that the appearance pattern count is not minute.

FIG. 14 shows determination results in a case in which the appearance pattern count being less than two is the condition for the appearance pattern count being minute. Accordingly, the functions Q and Y whose appearance pattern counts are one are determined to be minute with regard to the appearance pattern count. That is to say, in this case, the function Q and the function Y are identified as object functions.

Subsequently, the pattern extracting unit 14 performs counting (counting) of the number of object functions included in each pattern (S205). The number of object functions included in each pattern can be identified by referencing the execution count storage unit 122 (FIG. 7), in substantially the same way as in step S105 in FIG. 5.

Specifically, in a case in which the object functions are the function Q and the function Y, The pattern extracting unit 14 identifies patterns in which the function execution count of the function Q or the function Y in FIG. 7 is one or more. If the function execution count for only one of the function Q and the function Y is one or more in this pattern, the pattern extracting unit 14 sets the number of object functions included in this pattern to one. On the other hand, if the function execution counts for both of the function Q and the function Y are one or more in this pattern, the pattern extracting unit 14 sets the number of object functions included in this pattern to two. Note that the number of object functions included in a pattern whose function execution count is blank for both the function Q and the function Y is set to zero.

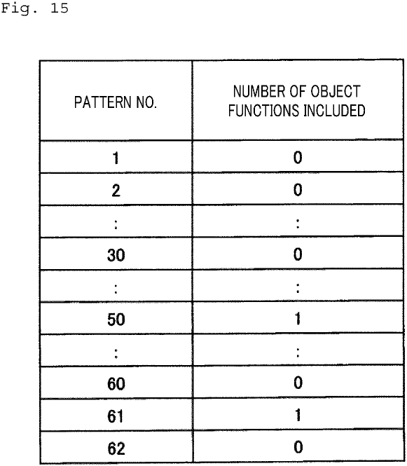

FIG. 15 is a diagram showing an example of counting results of the number of object functions included in the second embodiment. FIG. 15 shows counting results of the number of object functions included in a case in which the stored contents of the execution count storage unit 122 are as shown in FIG. 7, and the function Q and the function Y are object functions.

That is to say, in FIG. 7, with regard to Pattern 50, the function execution count of the function Q is one or more, and the function execution count of the function Y is blank. With regard to Pattern 61, the function execution count of the function Q is blank, and function execution count of the function Y is one or more.

From the above, in FIG. 10, the values of the “number of object functions included” for Pattern 50 and Pattern 61 are land 1, respectively, in this order, and the values of the “number of object functions included” for the other patterns are zero.

Thereafter is substantially the same as in the first embodiment.

As described above, according to the second embodiment, improvement-needed patterns can be extracted out of rare patterns, which are difficult to be extracted as improvement-needed patterns in the first embodiment. Accordingly, patterns including functions that need improvement can be efficiently extracted from patterns of execution processes of functions of the system.

Note that the first embodiment and the second embodiment may be combined. For example, the processing procedures of FIG. 12 may be executed following the processing procedures of FIG. 5.

Also, although distinction between executing agents (users executing the functions) of the functions making up the execution processes (patterns) of the functions is omitted in the above embodiments for the sake of convenience, the present embodiment may be applied to the execution processes (patterns) of functions with swim lanes in PTL 1, for example.

Note that in the above embodiments, the index calculating unit 12 is an example of a calculating unit. The object function identifying unit 13 is an example of an identifying unit. The pattern extracting unit 14 is an example of an extracting unit.

Although embodiments of the present invention have been described in detail as above, the present invention is not limited to these particular embodiments, and various types of modifications and alterations may be made within the scope of the subject matters of the present invention set forth in the Claims.

Reference Signs List

| | |
|---|---|
| 10 | Pattern extraction apparatus |
| 11 | Pattern generating unit |
| 12 | Index calculating unit |
| 13 | Object function identifying unit |
| 14 | Pattern extracting unit |
| 15 | Output unit |
| 100 | Drive device |
| 101 | Recording medium |
| 102 | Auxiliary storage device |
| 103 | Memory device |
| 104 | CPU |
| 105 | Interface device |
| 106 | Display device |
| 107 | Input device |
| 121 | System log storage unit |
| 122 | Execution count storage unit |
| B | Bus |

1. A pattern extraction apparatus, comprising:
a memory; and
a processor configured to execute:
calculating, on a basis of a history of an execution process of functions of a system, for each of the functions, a total execution count of the function;
identifying the function of which a percentage of the total execution count as to the total execution count of all of the functions or as to a sum of the total execution count is less than a threshold value; and
extracting, from patterns of the execution process, a pattern including the function identified by the identifying, on the basis of the history.

2. The pattern extraction apparatus according to claim 1,
wherein the calculating references information generated on the basis of the history, which indicates, for each of the patterns, an execution count of the pattern and an execution count of each of the functions that the pattern includes, and calculates, for each function, a total execution count of the function, and
wherein the extracting references the information and extracts the pattern including the function identified by the identifying.

3. A pattern extraction apparatus, comprising:
calculating, on a basis of a history of an execution process of functions of a system, for each of the functions a count of patterns of the execution process including the function;
identifying the function of which a count of the patterns is less than a threshold value; and
extracting, from patterns of the execution process, a pattern including the function identified by the identifying, on the basis of the history.

4. The pattern extraction apparatus according to claim 1,
wherein the extracting performs counting of a count of the functions identified by the identifying included for each of the patterns, and
wherein the processor further executes:
outputting the patterns extracted by the extracting , prioritized on a basis of the count included.

5. A pattern extraction method executed by a computer including a memory and a processor, the method comprising:
calculating, on a basis of a history of an execution process of functions of a system, a total execution count of the function for each of the functions;
identifying the function of which a percentage of the total execution count as to the total execution count of all of the functions or as to a sum of the total execution count is less than a threshold value; and
extracting, from patterns of the execution process, a pattern including the function identified in the identifying , on the basis of the history.

6. (canceled)

7. A non-transitory computer-readable recording medium having computer-readable instructions stored thereon, which when executed, cause a computer to function as the pattern extraction apparatus according to claim 1.
